(19) United States
(12) Patent Application Publication
(10) Pub. No.: US 2015/0113212 A1
(43) Pub. Date: Apr. 23, 2015

(54) INFORMATION DEVICE EQUIPPED WITH CACHE MEMORIES, APPARATUS AND PROGRAM USING THE SAME DEVICE

(71) Applicant: Hitachi, Ltd., Tokyo (JP)

(72) Inventors: Yukie HIRATSUKA, Yokohama (JP); Seiji MIURA, Hachioji (JP); Yukihide INAGAKI, Fujisawa (JP)

(21) Appl. No.: 14/587,065

(22) Filed: Dec. 31, 2014

Related U.S. Application Data
(63) Continuation of application No. 13/197,296, filed on Aug. 3, 2011.

(30) Foreign Application Priority Data
Aug. 25, 2010 (JP) 2010-188174

(51) Int. Cl. G06F 3/06

(52) U.S. Cl. CPC G06F 3/0613; G06F 3/0679; G06F 3/068; G06F 3/0625
USPC 711/103

(57) ABSTRACT

A read cache and a write cache are made up of two kinds of nonvolatile memories whose characteristics are different. For example, nonvolatile memory whose write endurance is high is assigned to the write cache, nonvolatile memory whose write endurance is low is assigned to the read cache, and the management tables of data in these caches are stored in the nonvolatile memory whose write endurance is high. Alternatively, nonvolatile memory that has a fast write speed but has a slow read speed is adopted for the write cache and nonvolatile memory that has a fast read speed but has a slow write speed is adopted for the read cache.

### CLAIM OF PRIORITY

This is a continuation application of U.S. Ser. No. 13/197,296, filed Aug. 3, 2011 which claims priority to Japanese patent application JP 2010-188174 filed on Aug. 25, 2010, the entire disclosures of all applications listed above are hereby incorporated by reference.

### FIELD OF THE INVENTION

The present invention relates to an information device with cache memories, an apparatus using it, and a program, and more specifically, to an information device that uses nonvolatile memory as cache memories and an apparatus using it.

### BACKGROUND OF THE INVENTION

In the related art, volatile memory has been used for cache memories. However, the volatile memory cache had a problem of consuming a lot of electric power in order to retain data. Moreover, there was a problem that data was lost by power supply cutoff etc. Therefore, the cache memories need to have contrivances of carrying a battery in order to supply electric power for a fixed period after power supply cutoff, not allowing data to stay in the cache for a long time, and the like.

Since the use of nonvolatile memory as the cache enables attainment of promotion of power saving and reduction in risk of data loss caused by power supply cutoff and the like, application of the nonvolatile memory for the cache is beginning to be considered.

Among nonvolatile memories that are currently on the market, one that has the largest size in the market is NAND flash memory. In recent years, its bit cost falls below that of Dynamic Random Access Memory (DRAM). Since write endurance of the NAND flash memory is as low as 10³-10⁶ (in the DRAM, it is 10¹⁶), it is used mainly in storage devices, such as a solid state drive.

Although read and write speeds of the NAND flash memory is fast as compared with the HDD, it is slow as compared with that of the DRAM by 1/10³⁻⁴ (while the random read and write speed of the DRAM is 6 to 40 ns, in the case of the NAND flash memory, the speed of the random write is 10⁵ ns and the speed of random read is 10⁴ ns). Moreover, power consumption of the NAND flash memory at the time of write is comparable to that of the DRAM (the power consumption of the NAND flash and the DRAM at the time of write per bit is 65 pJ).

In recent years, developments of next-generation memories, such as Phase Change Random Access Memory (PRAM), Magnetic Random Access Memory (MRAM), and Ferroelectric Random Access Memory (FeRAM) are being progressed. These nonvolatile memories have a feature of having high write endurance as compared with the flash memory. However, although when comparing them with the DRAM, the write endurance of the MRAM is comparable to that of the DRAM, the write endurance of the PRAM and the FeRAM is 10¹² and is inferior as compared with that of the DRAM. The PRAM and the FeRAM have random read and write performance comparable to that of the DRAM. Moreover, the read and write performance of the MARM is higher than the random read and write performance of the DRAM.

The power consumption of the PRAM and the MRAM at the time of write is comparable to that of the DRAM. Regarding the FeRAM, it has a feature that it is less than the power consumption of the DRAM at the time of write (while a writing power consumption of the DRAM per bit is 65 pJ, that of the FeRAM is 2 pJ).

Since the nonvolatile memory has various features as mentioned above, it is necessary to contrive how to use the nonvolatile memory when using it as a cache.

US 2007/0162693A1 describes an example of a magnetic disk drive equipped with nonvolatile memory as a cache. In this example, by storing a startup program of a computer (host), such as an operating system, and a frequently-used application program in nonvolatile memory, a data transfer rate to the host is improved, so that shortening of its startup time is achieved. Moreover, the disks are made to spin down when there is no access to the disks and write request data are written in the nonvolatile memory or read request data are transferred from the nonvolatile memory during a spin-down state, so that power saving is achieved.

### SUMMARY OF THE INVENTION

Since nonvolatile memory has the above features, it is necessary to devise how to use the nonvolatile memory when using it as a cache. For example, in the magnetic disk drive described in US 2007/0162693A1, if nonvolatile memory whose write endurance is low, such as the flash memory, is used for the cache, with increasing number of times of use (since the number of times of writing data in the cache reaches a predetermined number of times), the cache will be unusable, and a data transfer rate and a power saving effect of the magnetic disk drive will decrease rapidly.

Moreover, in the magnetic disk drive as mentioned above, if nonvolatile memory, such as flash memory, that has slow read and write speeds is used for the cache, for an access to a continuous area, a difference between the speeds of the nonvolatile memory and read and write speeds for the disks becomes small, and therefore a speed improvement effect by the cache is low. Moreover, in the magnetic disk drive as mentioned above, in the case of using the nonvolatile memory whose power consumption at the time of write is large, such as the flash memory, as a cache, as the writing quantity of the write data in the flash memory is increased, the power saving effect decreases.

One of the problems that the present invention intends to address is that when the nonvolatile memory is used as a cache, persistence of the effect of the cache is short because its write endurance is low. Another problem that the present invention intends to address is that when the nonvolatile memory is used as a cache, the speed improvement effect is low because its speed is slow. Further another problem that the present invention intends to address is that when the nonvolatile memory is used as a cache, the power saving effect lowers because its power consumption at the time of writing data is large.

It's an object of the present invention to provide an information device that resolves various problems, such as the write endurance, the read/write speeds or the power consumption in an information device placed on a data transfer path between multiple devices being different in data processing speed, and an apparatus that uses it.

One of typical examples according to the present invention is shown as follows. The information device of the present invention is an information device equipped with cache memory for read and cache memory for write on the data transfer paths among multiple devices that are different in data processing speed, and the cache memory for write consists of first nonvolatile memory and the cache memory for read consists of second nonvolatile memory whose characteristic is different from that of the first nonvolatile memory.

According to the aspect of the present invention, by forming read and write caches with a combination of two kinds of nonvolatile memories whose characteristics are different, it is possible to much enhance the effect by the cache and to provide the information device that meets various requirements and the apparatus using it.

### BRIEF DESCRIPTION OF THE DRAWINGS

FIG. 1 is a diagram showing a system configuration example of a first embodiment in which an information device of the present invention is applied to a magnetic disk drive;

FIG. 2A is a diagram showing a structure example of a table for managing data of a write cache in the first embodiment;

FIG. 2B is a diagram showing a structure example of a table for managing data of a read cache in the first embodiment.

FIG. 3 is a diagram for explaining an outline of operations of the first embodiment;

FIG. 4 is a diagram showing an example (flow) of a processing of counting an access frequency for each area in the first embodiment;

FIG. 5 is a diagram showing an example (flow) of a read processing in the first embodiment;

FIG. 6 is a diagram showing an example (flow) of a write processing in the first embodiment;

FIG. 7 is a diagram showing an example (flow) of a processing of moving data whose access frequency is high in the volatile memory read cache in the first embodiment to the nonvolatile memory read cache;

FIG. 8 is a diagram showing an example (flow) of a processing of moving data whose read access frequency is high in a volatile memory write cache in the first embodiment to the nonvolatile memory read cache;

FIG. 9 is a diagram showing a structure example of an access frequency management table for managing the access frequencies of all disk areas in the first embodiment;

FIG. 10 is a diagram showing an example (flow) of a processing of writing back the access frequency management table that was copied in the volatile memory to the access frequency management table on the disks in the first embodiment;

FIG. 11 is a diagram showing a system configuration example of a second embodiment in which the information device of the present invention is applied to a magnetic disk drive.

FIG. 12 is a diagram for explaining an outline of operations of the second embodiment;

FIG. 13 is a diagram showing a system configuration example of a third embodiment in which the information device of the present invention is applied to a magnetic disk drive;

FIG. 14 is a diagram for explaining an outline of operations of the third embodiment;

FIG. 15 is a diagram showing a system configuration example of an embodiment in which the information device of the present invention is mounted on a PC as an apparatus;

FIG. 16 is a diagram showing a system configuration example in which the information device of the present invention is mounted on an adapter to connect host with an HDD and an apparatus that uses it is constructed; and

FIG. 17 is a diagram showing a system configuration example of an embodiment in which the information device of the present invention is mounted on a storage system as an apparatus.

### DETAILED DESCRIPTION OF THE PREFERRED EMBODIMENTS

According to an exemplary embodiment of the present invention, the cache is formed with two kinds of nonvolatile memories that are different in write endurance: nonvolatile memory whose write endurance is high is adopted for the write cache and nonvolatile memory whose write endurance is low is adopted for a read cache, and management tables of data in those caches are stored in nonvolatile memory whose write endurance is high. Moreover, data in an area whose read-access frequency is high is extracted and written in the nonvolatile memory read cache whose write endurance is low. Thereby, persistence of an effect by the cache can be enhanced while suppressing increases in cost, power consumption, etc.

Moreover, according to another exemplary embodiment, the cache is configured with two kinds of nonvolatile memories that are different in read and write speeds: nonvolatile memory whose write speed is fast and whose read speed is slow is adapted for the write cache and nonvolatile memory whose write read speed is fast and whose write speed is slow is adapted for the read cache, respectively. Thereby, the improvement effect of the read and write speeds by the cache can be enhanced while suppressing increases in cost, power consumption, etc.

Moreover, according to another exemplary embodiment, the cache is configured with two kinds of nonvolatile memories that are different in power consumption: nonvolatile memory whose power consumption at the time of write is small is adopted for the write cache. Thereby, a power saving effect by a cache can be enhanced, while suppressing an increase in cost, a fall of read/write speeds, etc. Note that, in this application specification, the “information device” means one that is placed in a data transfer path between a pair of devices whose processing speeds are different and is equipped with “a cache memory device”. More specifically, one of the pair of devices is a computer, and the other thereof is a storage device or storage medium. The “storage device” includes a magnetic system storage device, an optical system storage device, and further a drive unit that uses flash memory for a storage medium (SSD: Solid State Drive). The “storage medium” includes a magnetic disk, an optical disk, semiconductor memory, etc. The “cache memory device” is a device that incorporates a controller, the nonvolatile memory read cache, and a nonvolatile memory write cache as a set. The “cache memory device” is appended a “volatile memory read cache” if needed. Incidentally, the controller in the cache memory device is expressed as a hard disk controller (an HDC) in the magnetic disk drive, and as a controller in other information device and apparatus.

The “nonvolatile memory” used in the present invention is memory that can be read and written, which includes, for example, ReRAM, STT-RAM, etc. in addition to previously enumerated PRAM (or PCM), MRAM, and FeRAM.

Moreover, in the present invention, the “memory that is different in characteristic” means discrete memory that adopts a memory technology different in physical principal. These “memories of different characteristics” make a difference mutually in any characteristic of “write endurance,” “read/write performance”, and “power consumption.” Moreover, as a result, these “memories of different characteristics” make a difference in terms of cost. Naturally, memory that is different from the others in terms of cost as a result of adopting a memory technology different in physical principle is one of the “memories whose characteristics are different” in the present invention. On the other hand, even if the memory that adopts the same physical principle as that of the other memory is different from the other in specification, performance, cost, or the like, they do not come under the “memory whose characteristics are different” of the present invention.

Hereinafter, embodiments of the information device equipped with the cache memory device of nonvolatile memory of the present invention will be described in detail by using drawings.

### First Embodiment

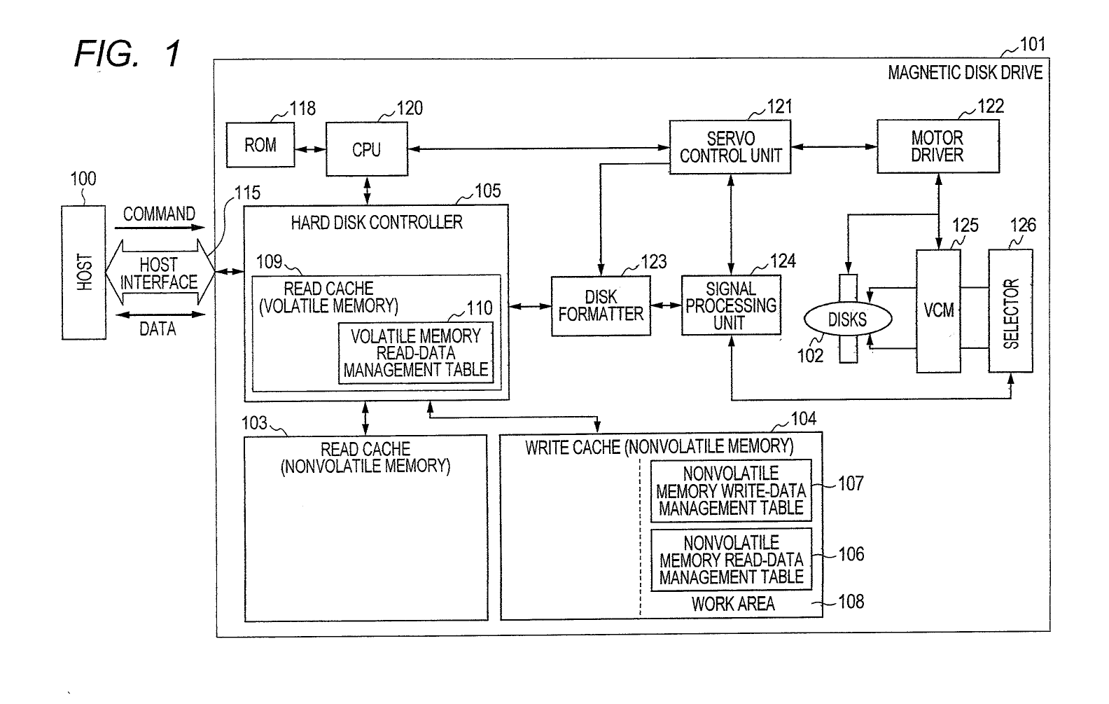

A first embodiment is configured as the apparatus by integrating an information device of the present invention into a magnetic disk drive and will be described referring to FIG. 1 to FIG. 10. Incidentally, although the embodiment of the information device will be explained considering the magnetic disk drive as an object, what the information device is applied to is not limited to the magnetic disk drive by this embodiment.

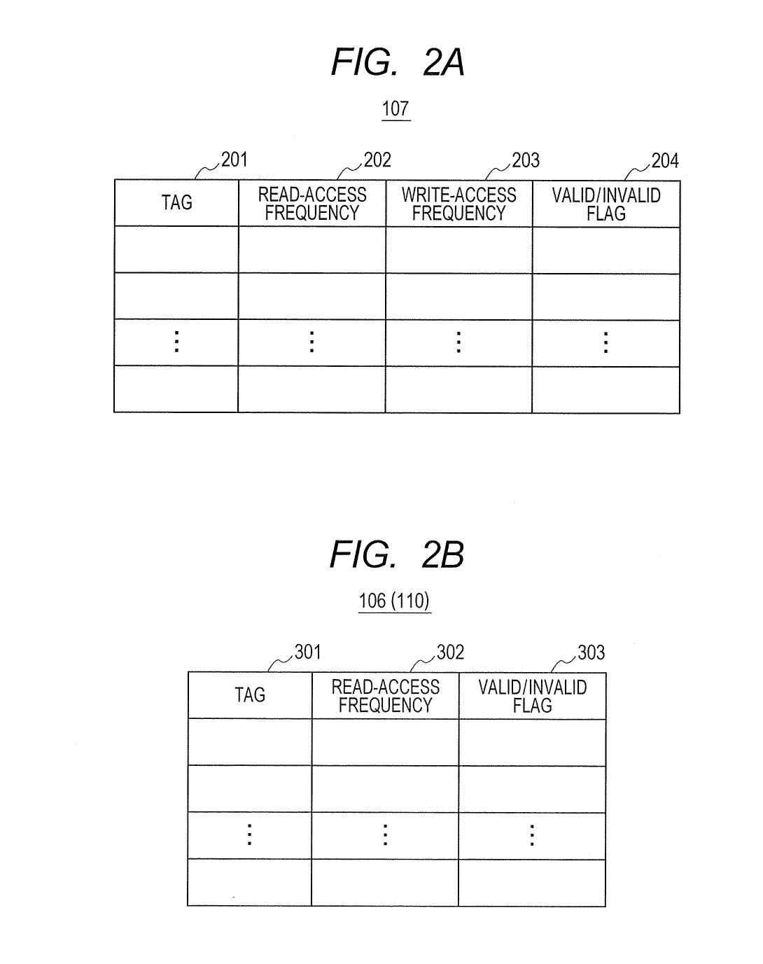

FIG. 1 shows a system configuration example of the magnetic disk drive in the first embodiment. FIG. 2A shows a structure example of a table for managing data of the write cache; FIG. 2B shows a structure example of a table for managing data of the read cache. A magnetic disk drive 101 is connected to a host computer (or a computer of a high-order device; hereinafter referred to simply as a host) 100 through an interface control unit 115 for giving and taking a command and data, and is equipped with the cache memory device for temporarily storing data on the data transfer path between a magnetic disks 102 and the host 100 that are different in data processing speed. This cache memory device consists of a nonvolatile memory write cache 104, a nonvolatile memory read cache 103, and a hard disk controller (hereinafter referred to as an HDC) 105. That is, the magnetic disk drive 101 is equipped with: program ROM 118 for accommodating a control program; a CPU (control processor) 120 that reads and executes the control program on this program ROM 118; the cache memory device including the nonvolatile memory (first nonvolatile memory) write cache 104 in which write request data is written, the nonvolatile memory (second nonvolatile memory) read cache 103 in which read request data is written, and a volatile memory read cache 109 (although the volatile memory read cache is mounted in the interior of the HDC in this embodiment, it may be mounted outside the HDC); and the HDC 105 for controlling data transfer between the host and the disks 102.

Furthermore, the magnetic disk drive is equipped with a servo control unit 121 for performing a control for moving a head to a position specified when reading and writing data, a voice coil motor (VCM) 125 for moving the head (illustration is omitted) following an instruction of this servo control unit, a motor driver 122 for controlling rotation of the disks 102, a spindle motor for disk rotation (illustration is omitted), and a selector 126 for selecting only a signal of the head specified from magnetic signals read from the heads. Furthermore, it is equipped with a signal processing unit 124 for converting analog data sent from the selector 126 into digital data or converting digital data sent from the HDC 105 into analog data and a disk formatter 123. The disk formatter 123 transfers read data sent from the signal processing unit 124 to the volatile memory read cache 109 by opening and closing a gate for read, and transfers write data transferred from the nonvolatile memory write cache 104 to the signal processing unit 124 by opening and closing a gate for write.

The HDC 105 in the above-mentioned cache memory device writes the write data received from the host 100 in the nonvolatile memory write cache, and reads data of addresses read-requested by the host 100 from the nonvolatile memory read cache 103 or the volatile memory read cache 109.

The nonvolatile memory for write and the nonvolatile memory for read are different in characteristic. That is, the nonvolatile memory 104 for write consists of nonvolatile memory whose write endurance is high, and the nonvolatile memory for read consists of the nonvolatile memory 103 whose write endurance is lower than that of the nonvolatile memory 104 for write. A reason that nonvolatile memories that are different in write endurance are used for the read cache and the write cache is, for example, that the nonvolatile memory whose write endurance is low is superior to the nonvolatile memory whose write endurance is high in respects of cost etc. What is necessary in using nonvolatile memories is just to assign two kinds of nonvolatile memories that are different in property to the read cache and the write cache, respectively, according to specifications required for the information device, such as cost and performance.

The nonvolatile memory write cache 104 is equipped with a nonvolatile memory write-data management table 107 and a nonvolatile memory read-data management table 106 for managing the write data in the nonvolatile memory and the read data in the nonvolatile memory, respectively. By placing the management tables of the write data of nonvolatile memory and of the read data of nonvolatile memory in the nonvolatile memory, loss of data in the cache caused by power supply cutoff etc. can be prevented. Moreover, by placing the nonvolatile memory write-data management table 107 and the nonvolatile memory read-data management table 106 on the write cache whose write endurance is high, depletion of the nonvolatile memory read cache whose write endurance is low can be mitigated.

Moreover, the volatile memory read cache 109 in the HDC 105 is equipped with a volatile memory read-data management table 110 for managing the read data in the volatile memory. Since by the HDC 105 being equipped with the volatile memory therein, it is possible for the nonvolatile memory read cache 103 whose write endurance is low to extract and store data whose read request frequency is high, the depletion of the nonvolatile memory read cache can be mitigated.

For example, the NAND flash memory and the PRAM are assigned to the nonvolatile memory read cache 103, and the MRAM is assigned to the nonvolatile memory write cache 104. Moreover, the DRAM is used for the volatile memory 1309. The above-mentioned memory combination is one example, and naturally other combination may be selected according to the characteristics of nonvolatile memories.

Moreover, an access frequency management table 111 (see FIG. 2B) for recording the access frequencies of all the data on the disks is provided on the disks 102.

The CPU 120 reads the data from the disks and writes the data on the disks, writes the data in the cache, and reads the data from the cache by executing various computer programs stored in the local memory (ROM) 118 and controlling the disk drive means and the HDC 105; therefore, it realizes reading of the data from the magnetic disk drive and writing of the data to the magnetic disk drive. That is, in a read processing, it reads the read requested data from the disks by controlling the disk drive means in response to the read request from the host, and at the same time controls the HDC 105 to write the read requested data being read to the volatile memory read cache 109 and transfer it to the host 100, while in a write processing, it controls the HDC 105 to write the write request data transferred from the host 100 to the nonvolatile memory write cache 104, and read the write data being written from the write cache and controls the disk drive means to write the write data on the disks 102.

Next, FIG. 2A shows a structure example of the nonvolatile memory write-data management table 107. The nonvolatile memory write-data management table 107 consists of Tag 201, read-access frequency 202, write-access frequency 203, and flag 204 indicating whether the data is valid or invalid. All sectors are given serial numbers by addresses of data (Logical Block Address (LBA)) specified by the host, and sector positions are specified by the numbers. Tag 201 shows a quotient obtained by dividing the LBA with the number of table entries. This LBA can be synthesized by using an offset address indicating the table entry as its lower order bit and setting the high-order address to the Tag 201 (in this case, the data size of the entry becomes a size of the sector that acts as an access unit of the magnetic disk drive).

An address of the table entry on the memory can be shown by adding the offset address of the entry to a base address indicating a start address of the data. The base address shall be recorded in the nonvolatile register or in the nonvolatile memory whose write endurance is high (shall be stored in a nonvolatile storage area).

FIG. 28 shows a structure example of the nonvolatile memory read-data management table 106. The nonvolatile memory read-data management table 106 consists of Tag 301, read-access frequency 302, and flag 303 indicating whether the data is valid or invalid. The Tag 301 is the same as Tag 201 of the nonvolatile memory write-data management table 107. Similarly, the LBA at the time of the read request from the host can be synthesized by using the offset address indicating the table entry as its lower bit and setting the high-order address to the Tag 301. The table 110 for managing the data on the volatile memory also has the same structure as that of the table of FIG. 2B.

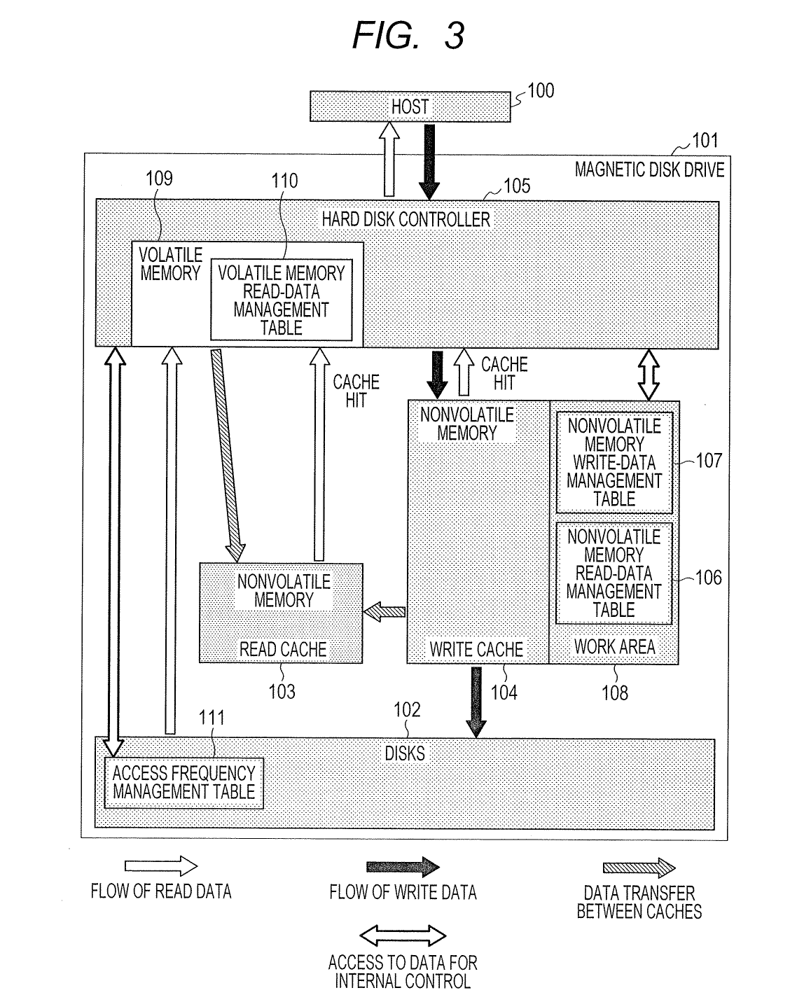

An outline of operations of the first embodiment will be explained with FIG. 3. The magnetic disk drive 101 gives and takes the read data or the write data between itself and the host 100 through the HDC 105, as shown in FIG. 3. The HDC 105 transfers the write data received from the host 100 to the write cache 104 in the write processing. Moreover, it writes the write data in the cache onto the disks 102 in cooperation with the disk drive means. Moreover, in the read processing, the HDC reads data of an address specified by the host 100 directly from the read cache (103, 109), or it reads from the disks 102 in cooperation with the disk drive means, writes it in the read cache 109, and at the same time transfers the data to the host. Moreover, the HDC accesses the management table 106, 107, and 110 of the data in the cache and the access frequency management table 111.

In the present invention, the read cache 103 and the write cache 104 are made up of two different nonvolatile memories whose characteristics are different, respectively: the nonvolatile memory whose write endurance is high is assigned to the write cache 104, and the nonvolatile memory whose write endurance is low is assigned to the read cache 103 giving first consideration to the data transfer speed, parts costs, etc. In this case, the table 107 for managing the data in the nonvolatile memory read cache 103 and the table 106 for managing the data in the nonvolatile memory write cache 104 are saved in a work area 108 that is provided on the write cache 104 whose write endurance is high. Storing the management tables 106, 107 of the data in the cache in the nonvolatile memory enables to prevent the loss of the data in the event of power supply cutoff. Moreover, placing the management tables 106, 107 of the data in the cache in the write cache 104 whose write endurance is high enables to prevent the depletion of the read cache 103 whose write endurance is low.

Although the volatile memory 109 is in the interior of the HDC 105, this volatile memory 109 may be placed outside the HDC 105. In the event of power supply cutoff, (if there is no supply of electric power by a battery etc.) the data on the volatile memory will be lost, but since what is lost is limited to the read data, it will not become data loss substantially.

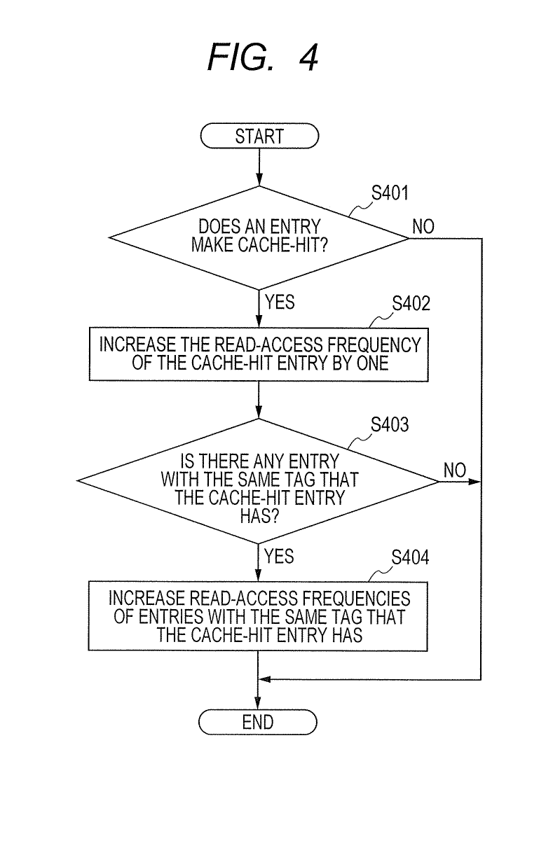

Although counting of an access frequency (202 and 203 of FIG. 2A, 302 of FIG. 2B) can be performed for every minimum data unit of the cache, it can also be performed for every unit area that was set up. FIG. 4 shows a flow of a processing of counting the read-access frequency per area using the Tag 301. This method is applicable in all the caches of the nonvolatile memory read cache 103, the volatile memory read cache 109, and the nonvolatile memory write cache 104.

In the read processing, whether a cache-hit is made is checked (Step S401), and if the cache-hit is made, the read-access frequency of the entry at which the cache-hit was made is increased by one (Step S402). At this time, an entry having the same Tag 31 as that of the entry at which the cache-hit was made is retrieved. If there is an entry having the same Tag 301 as the Tag 301 of the entry at which the cache-hit was made (Step S403), the read access frequencies 302 of all the corresponding entries will be increased by one (Step S404). Performing the above processing enables assigning weights to an area where access frequency is high.

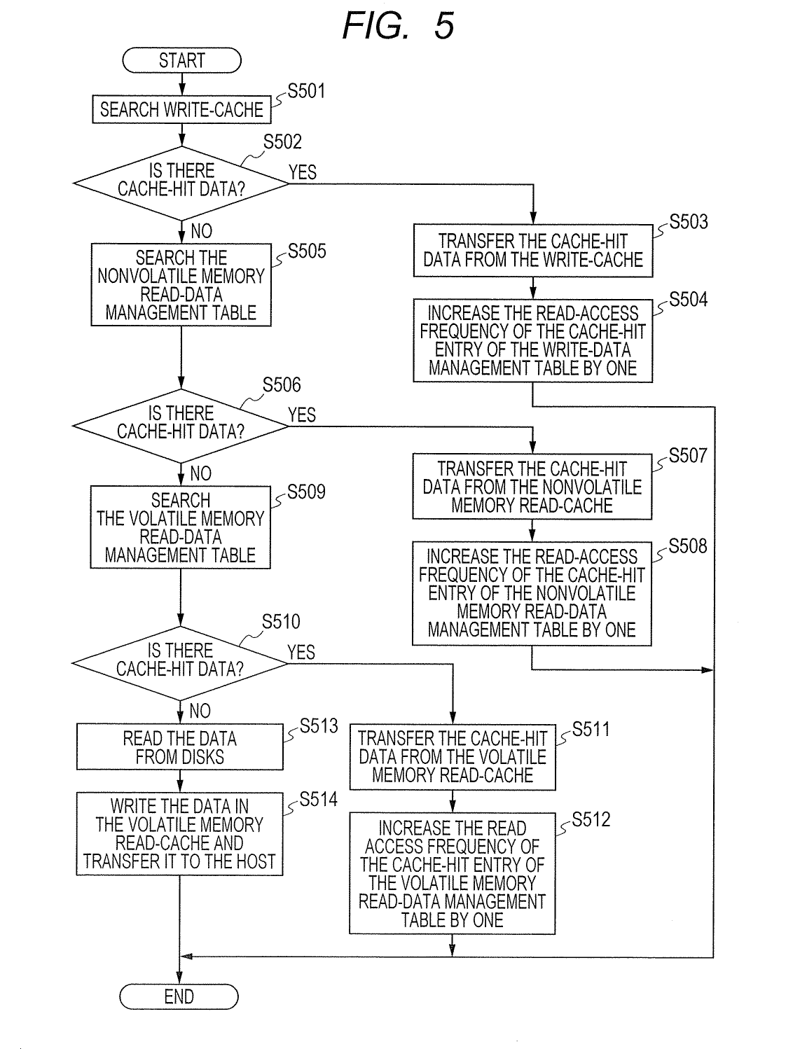

Next, a sequence of the read processing including a read cache control function will be explained using a flow of FIG. 5. Upon reception of the read request from the host, the HDC 105 accesses the nonvolatile memory write-data management table 107, and retrieves data on the write cache 104 (Step S501). Existence of the appropriate data is checked (Step S502), and if the cache-hit is made (if the appropriate edata exists in the cache 104), the cache-hit data will be transferred from the write cache 104 to the host (Step S503). Next, in the write-data management table 107, the read-access frequency 202 of the cache-hit data is increased by one (Step S504).

At Step S502, if the read request data does not exist on the write cache 104, the HDC 105 accesses the nonvolatile memory read-data management table 106 on the write cache 104, and retrieves data on the nonvolatile memory read cache 103 (Step S505).

Existence of the appropriate data is checked (Step S506), and if the cache-hit is made, the cache-hit data will be transferred from the nonvolatile memory read cache 103 to the host (Step S507). Next, in the nonvolatile memory read-data management table 106, the read-access frequency 302 of the cache-hit data is increased by one (Step S508). At Step S506, if there is no cache-hit data in the cache, next the HDC 105 will access the volatile memory read-data management table 110 on the volatile memory 109 and will retrieve data on the volatile memory read cache 109 (Step S509).

Existence of the appropriate data is checked (Step S510), and if the cache-hit is made, the cache-hit data will be transferred from the volatile memory read cache 109 to the host (Step S511). Next, in the read data management table 110 of the volatile memory 109, the read-access frequency 302 of the cache-hit data is increased by one (Step S512). At Step S510, if no cache-hit data exists in the read cache of the volatile memory 109, the CPU 120 will access the disks 102, will read the read requested data from disks 102 by working with servo controlling unit 121 (Step S513), and will write it in the read cache of the volatile memory 109 and further transfer it to the host by working with HDC 105(Step S514).

A series of processings were explained along a flow of FIG. 5, a search order of the nonvolatile memory read cache 103 and volatile memory read cache 109 may be any one of the following three cases: the nonvolatile memory read cache 103 precedes; the volatile memory read cache 109 precedes; and the nonvolatile memory read cache 103 and the volatile memory read cache 109 are searched simultaneously. Moreover, it does not matter that data of the nonvolatile memory write cache 104 and of the read cache of nonvolatile or volatile memories 103, 109 are retrieved simultaneously. Finally, what is necessary is just to treat a search result of the nonvolatile memory write cache 104 as data with the highest priority (just to transfer it to the host).

Incidentally, the flow of FIG. 5 is configured so that when the cache-hit is made, the read frequency of the data that made the cache-hit may be added in order to record the access frequency of the data in the cache.

As a result of searching all the caches, when a cache mistake occurs, the CPU accesses the disks 102 and reads the data by controlling servo control unit 121. However, the HDC is configured to write the data being read in the cache of volatile memory 109 (Step S514) and not to directly write the read data in the nonvolatile memory read cache 103. By restricting the writing of the read data to the nonvolatile memory read cache 103 in this way, it is possible to prevent a delay of the read processing (in the case where the write speed in the nonvolatile memory read cache is slow) or the depletion of the nonvolatile memory read cache.

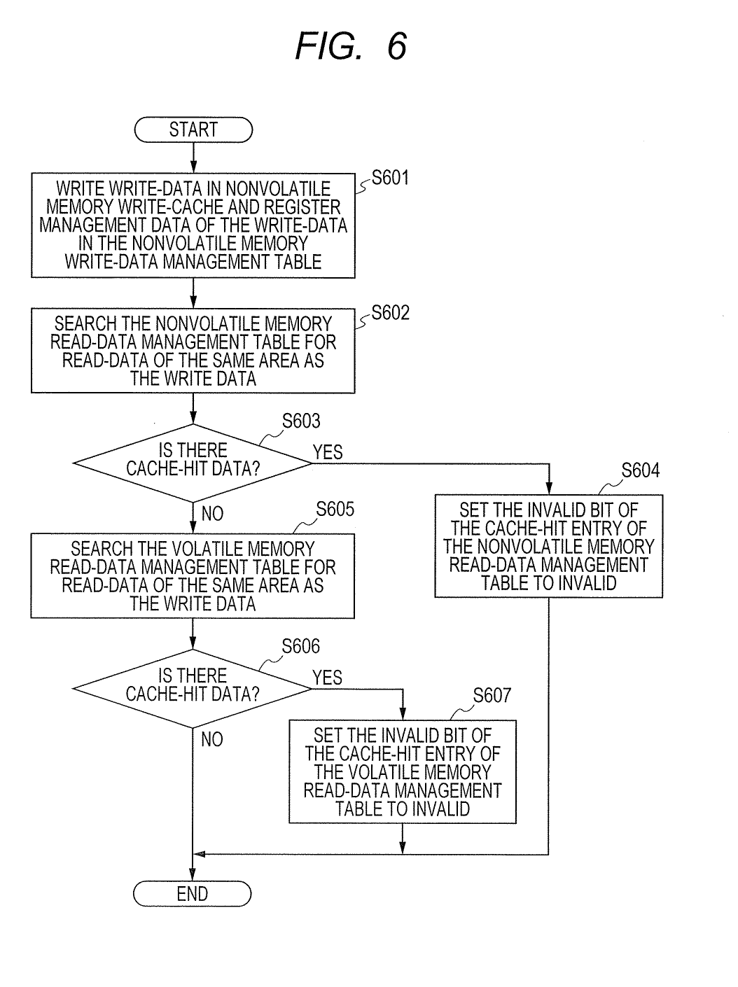

Next, a sequence of the write processing including a write cache control function will be explained using a flow of FIG. 6. The write requested data is written in the nonvolatile memory write cache 104 without fail, and its management data is registered in the nonvolatile memory write-data management table 107 (Step S601).

Although not described in the flow of FIG. 6, at the time when the write data is written in the write cache 104, the write-access frequency 203 of the nonvolatile memory write-data management table 107 may be incremented by one.

Next, the HDC searches the nonvolatile memory read-data management table 106 to retrieve whether there is any data of the same area (address) as that of the write data in the nonvolatile memory read cache 103 (Step S602).

The existence of the appropriate data is checked (Step S603), and if the cache-hit data exists, a valid/invalid bit of the cache-hit entry in the nonvolatile memory read-data management table 106 will be set invalid (Step S604). At Step S603, if there exists no data of the same area as that of the write data in the nonvolatile memory read cache 103, the HDC will access the volatile memory read-data management table 110 and will retrieve whether there will exist any data of the same area as that of the write data in the volatile memory read cache 109 (Step S605). The existence of the appropriate data is checked (Step S606), and if there exists the cache-hit data, a valid/invalid bit of the cache-hit entry in the volatile memory read-data management table will be set invalid (Step S607).

In the flow of FIG. 6, although the nonvolatile memory cache memory is processed first, the volatile memory may be processed first. Nonvolatile memory and volatile memory cache memories may be processed simultaneously.

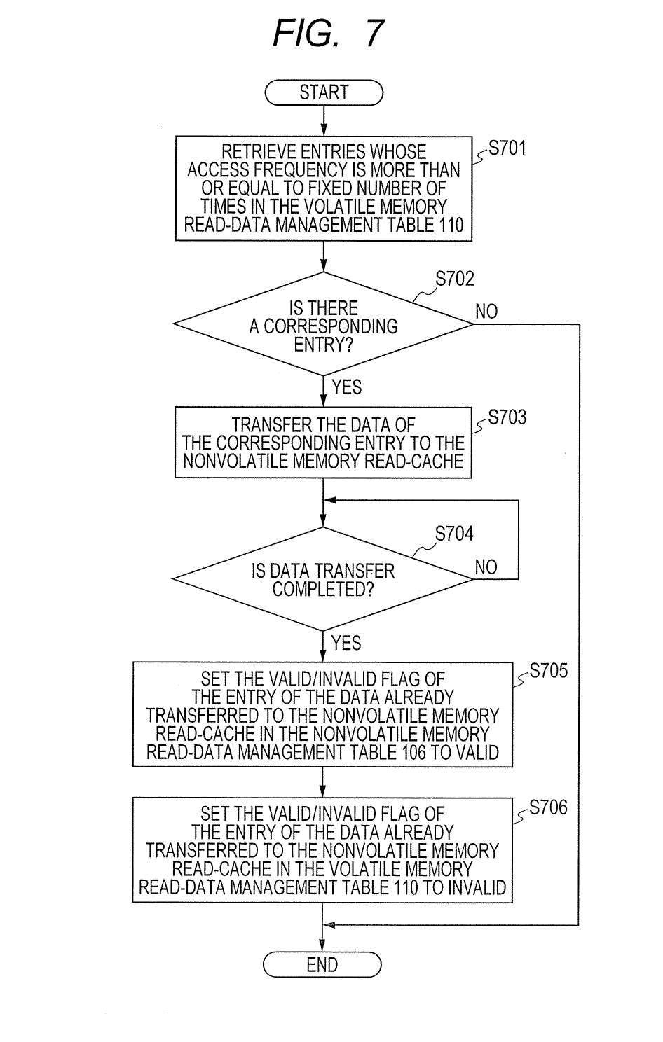

Next, a processing of writing the read data in the nonvolatile memory read cache 103 from the volatile memory read cache 109 will be explained using a flow of FIG. 7.

The data management table 110 of the volatile memory 109 is accessed first, the read-access frequency 302 is searched, and the entry whose access frequency becomes equal to or more than a fixed number of times is retrieved (Step S701). The existence of a corresponding entry is checked (Step S702), and if there is the corresponding entry, data of the entry will be transferred to the nonvolatile memory read cache (Step S703).

Next, it is checked whether transfer of the cache-hit data from the volatile memory 109 is completed (Step S704). This processing is repeated until the transfer is completed. If the transfer is completed, management information of the cache-hit data is registered in the nonvolatile memory read-data management table 106, and at the same time a valid/invalid flag 303 of the cache-hit data is set valid (Step S705).

Next, the read data management table 110 of the volatile memory 109 is accessed, and a value of the valid/invalid flag of the transferred data is set invalid (Step S706).

The processing of FIG. 7 is performed at the flowing timings: when an entry such that the read-access frequency reaches a predetermined number of times in the cache of the volatile memory 109 comes about; at regular intervals; in the event of shutdown; etc.

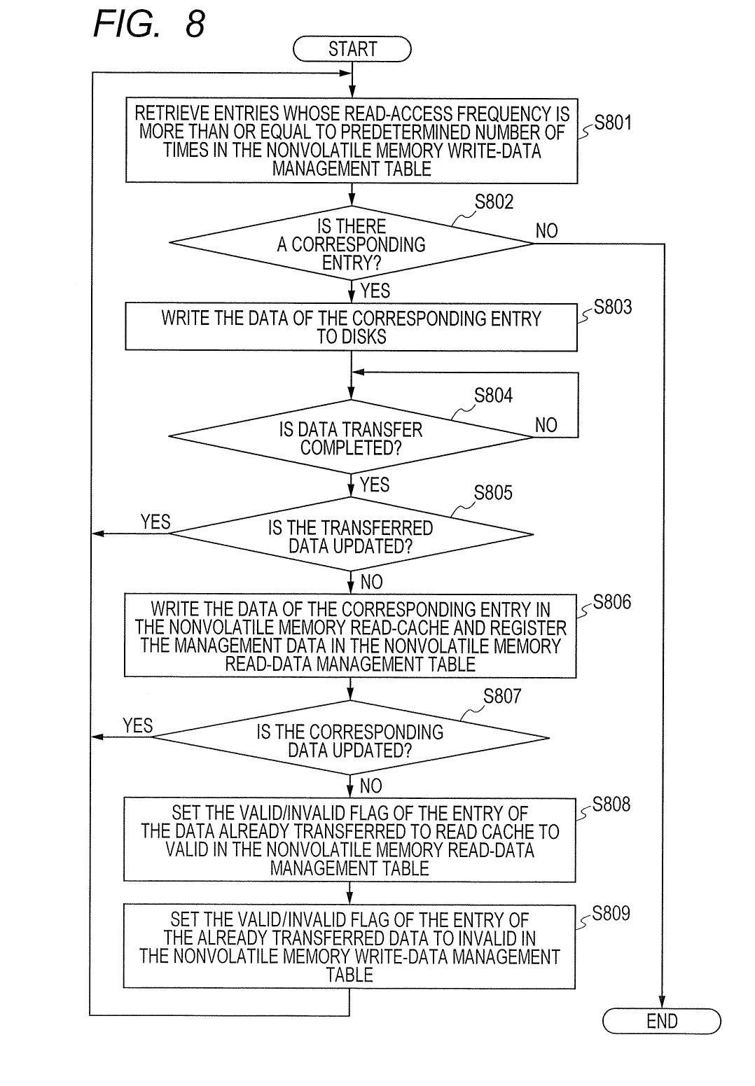

Next, a processing of writing data whose read frequency in the nonvolatile memory write cache 104 is high from its write cache 104 to the nonvolatile memory read cache 103 will be explained using a flow of FIG. 8.

The HDC 105 accesses the nonvolatile memory write-data management table 107 recorded in the work area 108 of the nonvolatile memory write cache 104 and checks whether there is any entry whose read-access frequency 202 is higher than a predetermined access frequency (Step S801).

The corresponding entry is checked (Step S802), and if there is no corresponding entry, the processing will be ended. At Step S802, if there is the corresponding entry, data of the corresponding entry will be written on the disks 102 (Step S803).

Next, it is checked whether the data transfer from the nonvolatile memory write cache 104 to the disks 102 is completed (Step S804), and if the transfer is not completed, Step S804 will be repeated. When the data transfer to the disks is completed, it is checked whether the already transferred data has been updated in the nonvolatile memory write cache (Step S805). If the transferred data has been updated in the nonvolatile memory write cache, the flow will return to Step S801; and if the transferred data has not been updated, the data of the corresponding entry will be written in the nonvolatile memory read cache 103, its management data will be registered in the nonvolatile memory read-data management table 106 (Step S806), and the valid/invalid flag of the entry is set invalid at this point. Next, the HDC checks whether the data being transferred to the read cache 103 has been updated in the nonvolatile memory write cache (Step S807), and if not updated, the valid/invalid flag of the entry of the data being already transferred to the read cache will be set valid (Step S808). Next, the HDC sets the valid/invalid flag of the data being already transferred to be invalid in the nonvolatile memory write-data management table 107 (Step S809), and the flow returns to Step S801. If the data being transferred to the read cache 103 has been updated at Step S807, the flow will return to Step S801.

The processing of FIG. 8 is performed at the flowing timings: when an entry whose read-access frequency 202 becomes equal to or more than a predetermined number of times in the nonvolatile memory write cache 104 occurs; or when an rate of empty area on the write cache 104 becomes equal to or less than a constant rate; or at evenly spaced time intervals; or in the event of shutdown; or the like.

In the flow of FIG. 8, although the data whose read-access frequency was high was transferred to the nonvolatile memory cache, the data may be configured to be extracted by discontinuous pieces of data being selected in addition to the height of the read-access frequency. That is, the transfer may be performed as follows: the read frequency of the data on the first nonvolatile memory 104 is counted, pieces of data whose read access frequencies are high on this first nonvolatile memory are extracted, and discontinuous pieces of data that is the pieces of data with continuous pieces of data removed are transferred to the second nonvolatile memory 103. This is because the much the discontinuous data is placed in the read cache, the higher the speed improvement effect of the read cache becomes, due to a fact that an access to the continuous area on the disks is fast.

In the processing of the flow of FIG. 8, before moving the data of the nonvolatile memory write cache 104 to the nonvolatile memory read cache 103, the write data is written on the disks 102 (Step S803). However, this may be written on the disks 102 after it is temporarily written in the nonvolatile memory read cache 103. However, it needs to be given an identifier so that the temporarily written data may be understood as the write data in that case. Therefore, it is necessary to provide a flag indicating transfer data from the nonvolatile memory write cache in the structure of the nonvolatile memory read-data management table of FIG. 2B in that case. When a situation of writing the write data in the nonvolatile memory onto the disks later arises, data that is not written on the disks can be written thereon with reference to this flag.

In the flows of FIG. 7 and FIG. 8, by retaining a frequency of the read access of data existing in the volatile memory or nonvolatile memory cache, a processing of moving the data between their caches based on the frequency was explained.

In the below, by recording the access frequency of read or write considering all areas on the disks as objects, not limiting the data in the caches, it becomes possible to perform the followings: at the time of start or in the event of shutdown etc., extracting data in an area where the read-access frequency is especially high among all the areas on the disks and replacing it with data whose access frequency is low in the nonvolatile memory; or selecting data in an area whose write-access frequency is low among all the areas on the disks from the write cache and writing it on the disks.

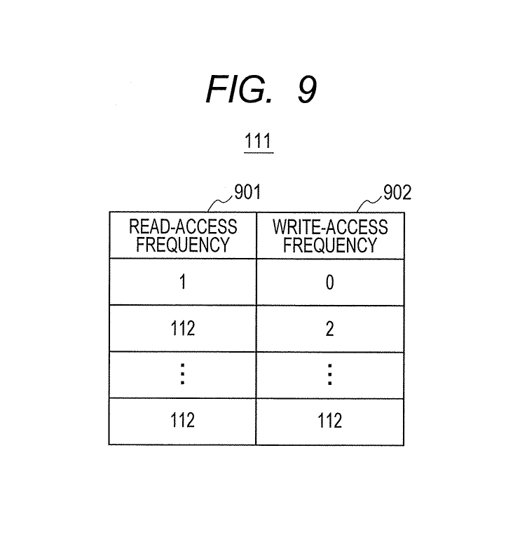

FIG. 9 shows a structure example of the access frequency management table 111 for recording the access frequencies of all the data on the disks 102. The access frequency management table 111 consists of read-access frequency 901 and write-access frequency 902. Considering all the areas of the disks 102 as objects, if the access frequency is checked for every sector that is an access minimum unit of the disks, the number of table entries will become the total number of the sectors of the disks. In that case, since the size of the access frequency management table 111 becomes large, it is necessary to store the table in an area on the disks 102. Moreover, since the access frequency management table 111 is data for management used for optimizing placement of the data within the magnetic disk drive, it needs to be saved in a system area on the disks that are not updated by the host. The base address that indicates a start address of the access frequency management table is recorded on the disks or in the nonvolatile memory.

Moreover, in the case where the size of the access frequency management table 111 is intended to be made small, there is a method whereby the area on the disks is divided into some areas and the access frequency is taken for each area. For example, it is allowable that based on Tags 201, 301 of the table shown in FIG. 2A and FIG. 2B, the disks are divided into some areas and the access frequency is managed for each area. That is, it is allowable that a unit area is set up for every high-order address of table entries in each of the data management tables 106, 107, and 110, and entries whose tag values are identical are all assumed to access the same area and the frequency of read or write access to the area may be managed.

As long as the size of the access frequency management table 111 is such a size as can be put into the work area 108 of the write cache 104 sufficiently, the table data may be recorded in the work area and may be accessed. Alternatively, it may be allowable that in case where the frequency table is formed sector by sector and the size of the table becomes large, a part of the table is copied in the cache of the volatile memory 109, the copied portion is made accessible and the portion is made to be updated and referred to any time. This is because in the case where the magnetic disk drive 101 is configured so that the frequency table on the disks 102 area is always accessed and the access frequency of the table is updated and referred to, updating and referring to the data in the table takes time.

In this case, since a part of the access frequency management table 111 is stored in the volatile memory 109, in the event of power supply cutoff, that table data copied in the volatile memory 109 will be lost. However, if the data of the access frequency management table on the volatile memory 109 is written in the access frequency management table 111 on the disks at an appropriate timing, since a situation of the access frequency at a short while before the power supply cutoff is recorded on the disks 102, it will not become a serious problem.

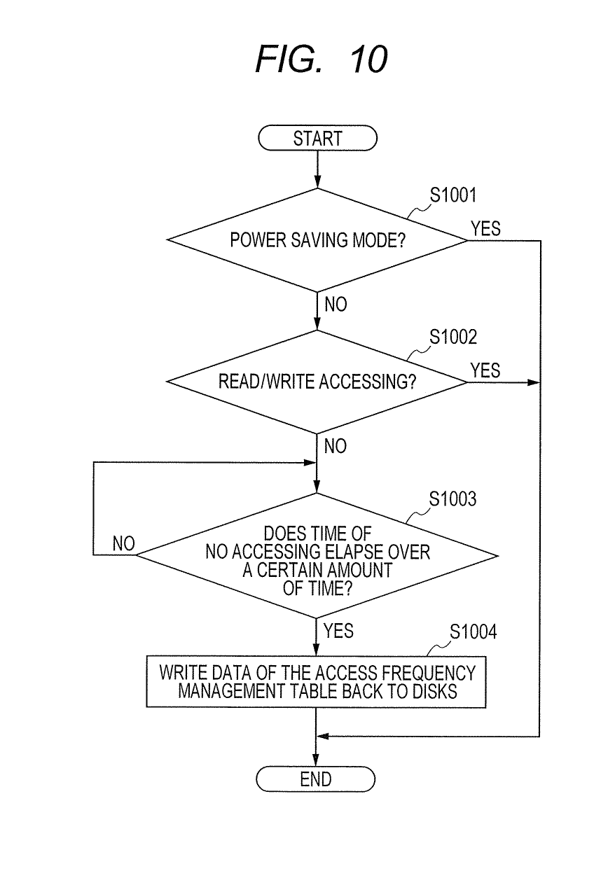

FIG. 10 shows a flow of a processing of writing back the access frequency management table that was copied on the volatile memory 109 (a part of the entire table) onto the access frequency management table 111 on the disks 102.

An HDC 105 checks whether the magnetic disk drive 101 is in a power saving mode (Step S1001), and if it is not in the power saving mode, checks whether it is currently in read/write access (Step S1002). If the magnetic disk drive 101 is not in read/write access, the disk controller 105 checks whether a certain amount of time has elapsed (a lapse time from the last access can be checked by using a timer in the magnetic disk drive) (Step S1003). If the time of no accessing elapsed over the certain amount of time, the access frequency management table copied in the volatile memory is written back in the access frequency management table for the whole that is recorded in the system area on the disks (Step S1004). The flow returning to Step S1003, if the time of no accessing does not elapse over the certain amount of time, the flow repeats Step S1003 until the certain amount of time elapses.

The flow returning to Step S1002, if it is in the read/write access, the processing will be ended. The flow returning to Step S1001, if the processing is in the power saving mode, the processing will be ended.

By the above processing, it is possible to, at a right time when the magnetic disk drive 101 is in an active state and the read and write is not performed, i.e., at an idle time, write back the access frequency management table on the volatile memory in the access frequency management table on the disks and to alter the access frequency management table on the disks to be in a latest state.

According to this embodiment, by forming the read/write caches with a combination of two kinds of nonvolatile memories that are different in write endurance, it is possible to provide an information device that realizes high persistence of the effect while suppressing an increase in cost and an increase in power consumption.

### Second Embodiment

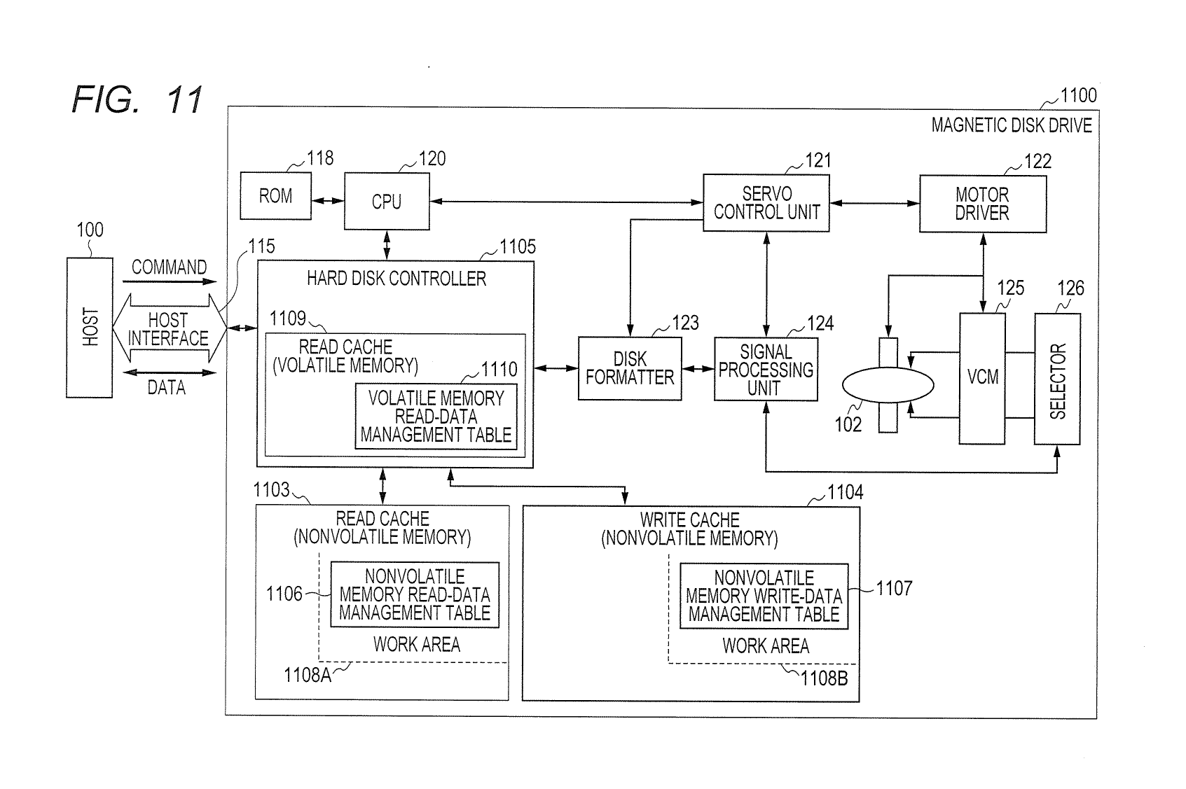

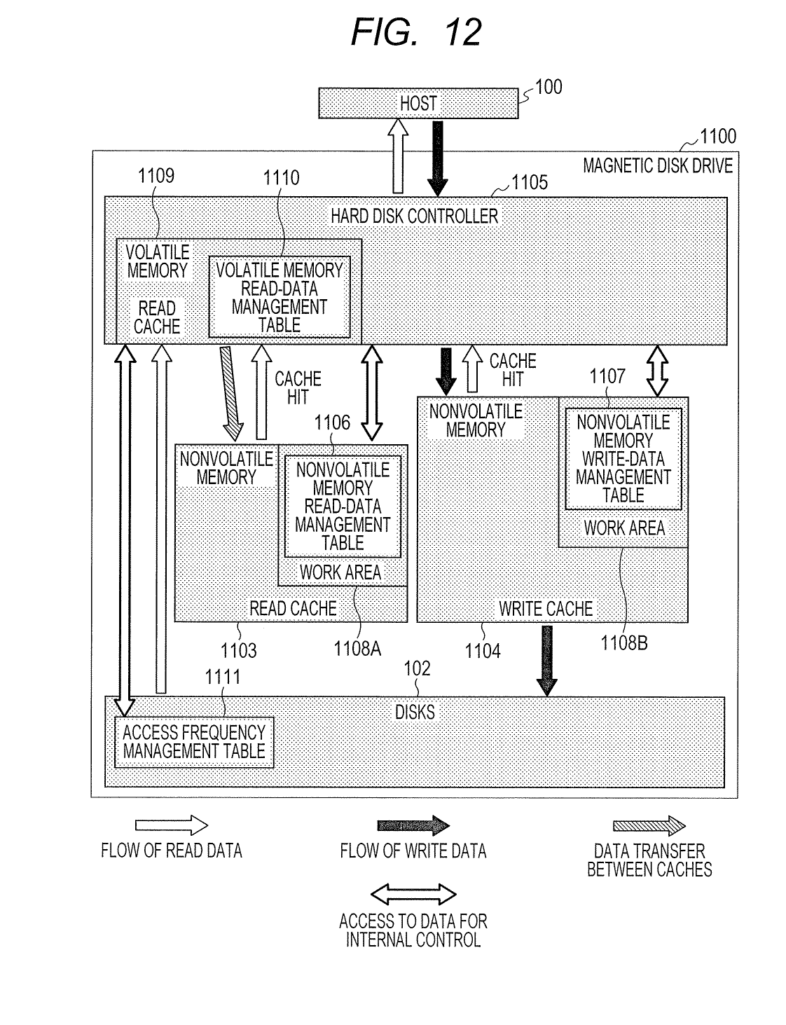

A second embodiment in which an information device of the present invention is applied to a magnetic disk drive will be described referring to FIG. 11 and FIG. 12. A system configuration example of the magnetic disk drive in the second embodiment is shown in FIG. 11. A magnetic disk drive 1100 is equipped with the cache memory device that has a HDC 1105, a nonvolatile memory read cache 1103, the nonvolatile memory write cache 1104, and volatile memory 1109 on the HDC 1105. In the second embodiment, nonvolatile memory that has a fast read speed but has a slow write speed is assigned to the nonvolatile read cache 1103 and nonvolatile memory that has a fast write speed but has a slow read speed is assigned to the write cache 1104. A reason why the nonvolatile memories that are different in read speed and write speed are used for the read cache and the write cache is that using the memories properly in such a way is reasonable in respects of cost, etc.

For example, the PRAM is assigned to the read cache 1103 of nonvolatile memory, and the MRAM is assigned to the write cache 1104 of nonvolatile memory.

Although in the read cache, a requirement for the read speed is high, a requirement for the write speed is low. On the other hand, although in the write cache, the requirement for the write speed is high, the requirement for the read speed is low. Therefore, the above way of using the memory properly becomes possible. What is necessary is just to use suitably properly two kinds of nonvolatile memories that are different in read speed and write speed according to a specification required of the cache memory device, such as performance of data processing speed etc. and a cost as a read cache and a write cache.

Since the nonvolatile memory that has a fast read speed but a slow write speed is assigned for the read cache and the nonvolatile memory that has a fast write speed but a slow read speed is assigned for the write cache, respectively, the tables for managing the data in the caches are placed in the respective caches. That is, a nonvolatile memory read-data management table 1106 for managing the read data in the nonvolatile memory read cache 1103 is placed in a work area 1108A of the nonvolatile memory read cache, and the nonvolatile memory data management table 1107 for managing the write data in the nonvolatile memory write cache 1104 is placed in a work area 1108B of the nonvolatile memory write cache. This is because, in order to make the most of read and write speed characteristics of the nonvolatile memory cache, the read speed and the write speed to each table need to be equal to or more than the read speed and the write speed of the nonvolatile memory caches.

Like the first embodiment, whether the volatile memory read cache 1109 and a volatile memory read-data management table 1110 are provided in HDC 105 depends on a difference between the read speed of the data from the disks and the write speed of the data in the nonvolatile memory read cache. That is, if the write speed of the nonvolatile memory read cache is slower than the read speed of the data from the disks, it will be necessary to provide the volatile memory read cache in the HDC. If there is no speed difference as mentioned above, it is not necessarily required to provide the volatile memory read cache in the HDC. Volatile memory may be provided outside the HDC if it is required to be provided.

Moreover, an access frequency management table 1111 is recorded on the disks 102. Configurations of the nonvolatile memory write-data management table 1107, the nonvolatile memory read-data management table 1106, the volatile memory read-data management table 1110, and the access frequency management table 1111 are the same as the configurations shown in the first embodiment, respectively. Configurations of other devices are the same as those of the first embodiment.

An outline of operations of the second embodiment will be explained with FIG. 12. The magnetic disk drive 1100 gives and takes the read data or the write data between itself and the host 100 through the HDC 1105, as shown in FIG. 12. The HDC 1105 transfers the write data received from the host 100 to the write cache 1104 in the write processing. Moreover, it writes the write data on the write cache 1104 onto the disks 102 in cooperation with the disk drive means. Moreover, in the read processing, the HDC 1105 either reads data of an address specified by the host 100 issuing the read request directly from the nonvolatile or volatile memory read cache 1103, 1109 or writes the read requested data from the disks 102 in cooperation with disk drive means in the volatile memory read cache 1109, and at the same time transfers the data in the volatile memory read cache to the host. Moreover, the HDC 1105 accesses the management tables 1106, 1107, and 1110 of the data in the caches and the access frequency management table 1111 in a course of the read processing or the write processing.

In the second embodiment, the data in the nonvolatile memory caches is managed by the nonvolatile memory read-data management table 1106 being placed in the nonvolatile memory read cache 1103 and by the nonvolatile memory write-data management table 1107 being placed in the nonvolatile memory write cache 1104, respectively.

A reason of adopting such a configuration as described above is that, in order to make the most of the read and write speed characteristics of the nonvolatile memory cache, the read speed and the write speed to each table need to agree with the read speed and the write speed of the nonvolatile memory caches or to be larger than them, respectively.

According to this embodiment, by assigning the nonvolatile memory that has a fast write speed but a slow read speed to the write cache and assigning the nonvolatile memory that has a fast read speed but a slow write speed to the read cache, it is possible to attain improvement of the read and write speeds by the cache while suppressing increases in cost, power consumption, etc.

### Third Embodiment

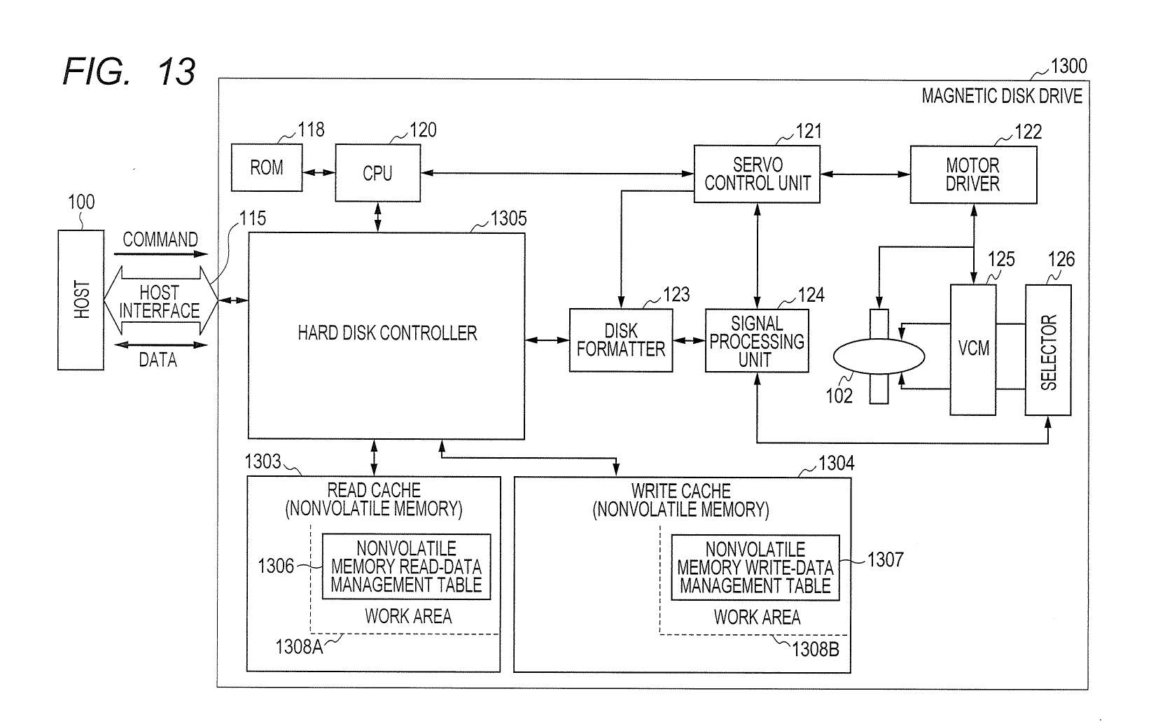

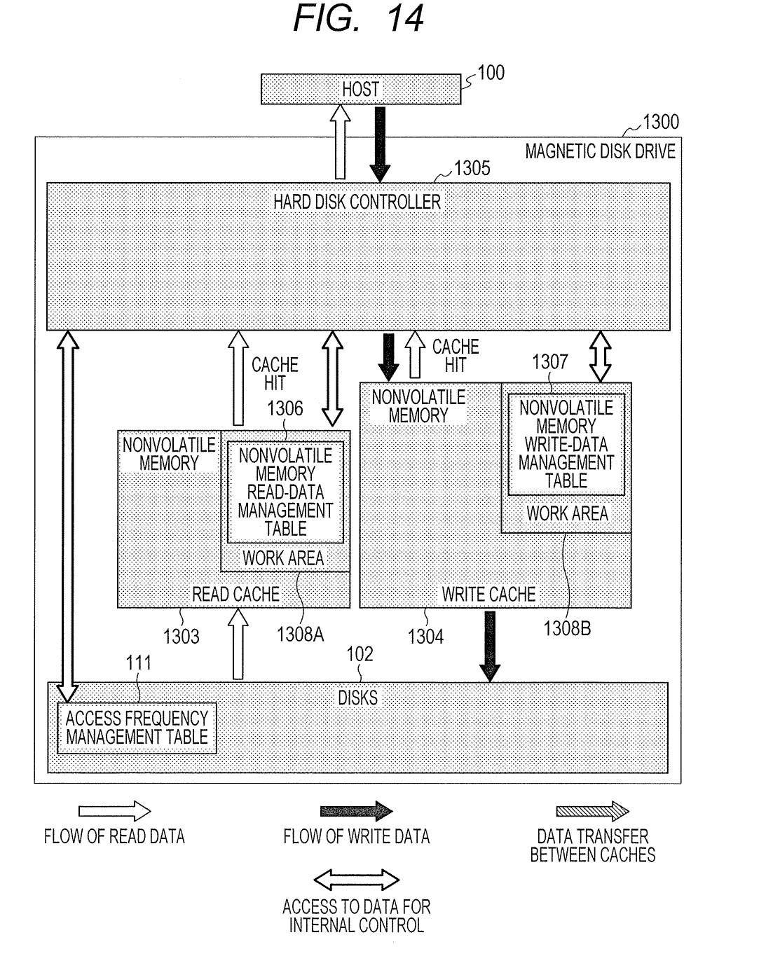

A third embodiment in which the information device of the present invention is applied to a magnetic disk drive will be described referring to FIG. 13 and FIG. 14. FIG. 13 shows a system configuration example of the magnetic disk drive in the third embodiment. A magnetic disk drive 1300 is equipped with the cache memory device that has an HDC 1305 and two kinds of cache memories of a nonvolatile memory read cache 1303 and a nonvolatile memory write cache 1304.

The magnetic disk drive of this embodiment is such that the read cache and the write cache are made up of two kinds nonvolatile memories that are different in power consumption, and a nonvolatile memory write-data management table 1307 for managing data of the nonvolatile memory write cache 1304 and a nonvolatile memory read-data management table 1306 for managing data of the nonvolatile memory read cache 1303 are recorded in respective work areas 1308B, 1308A of the nonvolatile memory write cache and the nonvolatile memory read cache, respectively.

In the third embodiment, the cache memory of volatile memory is not placed in the interior of the HDC 1305. The power consumption required by the read processing can be curtailed by reducing the number of caches in the read processing.

Configurations of the nonvolatile memory write-data management table 1307 and a nonvolatile memory read-data management table 1306 are the same as the configurations shown in the first embodiment, respectively. Configurations of other devices are the same as those of the first embodiment.

In this embodiment, for example, the read and write caches are constructed with two kinds of nonvolatile memories that are different in power consumptions at the time of write, and the write cache 1304 is made up of the nonvolatile memory whose power consumption at the time of write is small, or the read cache 1303 is made up of the nonvolatile memory whose power consumption at the time of write is small.

The MRAM is enumerated as the nonvolatile memory whose power consumption at the time of write is small. As an example mentioned above, it is conceivable that a nonvolatile memory cache whose power consumption at the time of write is small is assigned to a cache where a total amount of data to be written in the cache by a control of the HDC 1305 becomes larger, and a nonvolatile memory whose characteristic of the power consumption at the time of write is relatively inferior but whose other characteristics are superior is assigned to other cache. By doing in this way, it becomes possible to achieve reduction of the power consumption related to cache control.

Moreover, it is also recommendable that the read cache and the write cache are made up of two kinds of nonvolatile memories that are different in power consumption at the time of read, and the nonvolatile memory whose power consumption at the time of read is small is assigned to the read cache.

As the above-mentioned example, a cache of nonvolatile memory whose power consumption at the time of read is small is adopted for the nonvolatile memory read cache for storing an execution program such as an OS and an application. By doing in this way, it becomes possible to achieve reduction of the power consumption of the read cache of the nonvolatile memory whose read frequency becomes higher than the write frequency.

An outline of operations of the third embodiment will be explained with FIG. 14. The magnetic disk drive 1300 gives and takes the read data or write data, between itself and the host 100 through the HDC 1305, as shown in FIG. 14. In the write processing, the HDC 1305 transfers the write data received from the host 100 to the write cache 1304. Moreover, it writes the write data on the write cache 1304 onto the disks 102 in corporation with the disk drive means. Moreover, in the read processing, the HDC 1305 either reads data of an address specified by the host 100 issuing the read request directly from the nonvolatile memory read cache 1303 or writes the read requested data being read from the disks 102 in the nonvolatile memory read cache 1103 in corporation with the disk drive means, and at the same time transfers the data in the nonvolatile memory read cache to the host. Moreover, the HDC 1305 accesses the management tables 1306, 1307, and the access frequency management table 111 in the cache in a course of the read processing or the write processing.

In the third embodiment, although the nonvolatile memory read-data management table 1306 is placed in the nonvolatile memory read cache 1303, the nonvolatile memory write-data management table 1307 is placed in the nonvolatile memory write cache 1304, respectively, and thereby the data in the nonvolatile memory caches is controlled, the configuration does not need to be limited by this. Placement of the tables shall be placed so that the power consumption for accesses of read and write may become the minimum.

Moreover, in order to suppress the power consumption, the volatile memory read cache is not set up in the interior of the HDC 1305, but the cache memory device is configured so that the read data being read from the disks 102 is written directly in the read cache 1303 of nonvolatile memory in the third embodiment.

According to this embodiment, by forming the read and write caches with two kinds of nonvolatile memories that are different in power consumption characteristic, it is possible to suppress the power consumption required for a processing of caches while suppressing an increase in cost, reduction in read and write speeds, etc.

### Fourth Embodiment

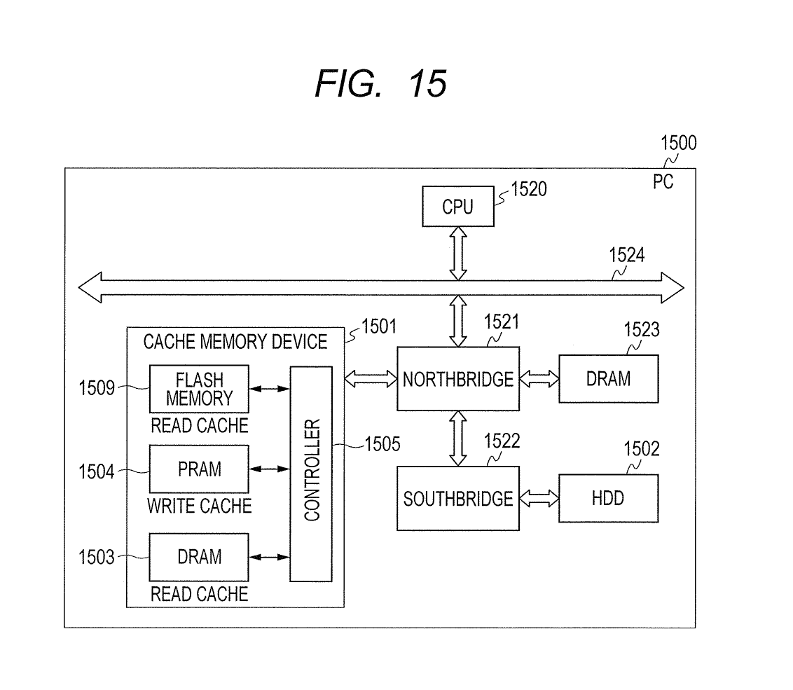

FIG. 15 shows a system configuration example of a case where the information device of the present invention is mounted on a PC (personal computer) to construct an apparatus. A PC 1500 consists of a CPU 1520 that is a central processing unit, DRAM 1523 that is main memory, a cache memory device 1501 serving as auxiliary memory, a northbridge for controlling the data transfer mainly between the CPU and the main memory, a southbridge for controlling the data transfer mainly between the storage devices such as an HDD and the northbridge, and the like. The CPU and the northbridge are connected by a CPU bus 1524, and the northbridge and the main memory are connected by a memory bus. Moreover, the northbridge and the southbridge are connected by a PCI bus or dedicated bus.

The information device 1501 of the present invention can perform connection of the northbridge, for example, using a dedicated bus.

The cache memory device 1501 of the present invention includes three kinds of cache memories: a read cache 1503 made up of volatile memory such as the DRAM, a write cache 1504 made up of nonvolatile memory such as the PRAM, and a read cache 1509 made up of nonvolatile memory such as the flash memory, and a controller 1505. A specific configuration and operations of the cache memory device 1501 are the same as those of the cache memory device of any one of the first embodiment to the third embodiment.

According to this embodiment, by forming the read and write caches by a combination of two kinds of nonvolatile memories whose characteristics are different, the effect by the cache can be enhanced while suppressing increases in cost, power consumption, etc. or the effect by the cache can be brought out to the maximum extent, so that it is possible to provide a PC that meets various requirements, such as low cost, high data transfer rate, and low power consumption.

### Fifth Embodiment

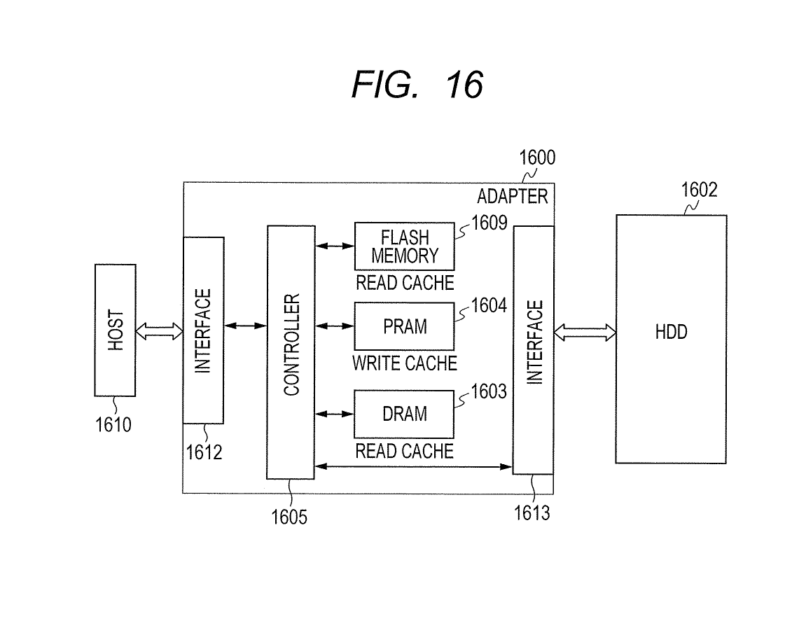

FIG. 16 shows a system configuration example when the information device of the present invention is mounted on an adapter for connecting the host and the HDD. An adapter 1600 is equipped with the cache memory device and interfaces 1612, 1613. The cache memory device includes three kinds of cache memories: a read cache 1603 made up of volatile memory such as the DRAM; a write cache 1604 made up of nonvolatile memory such as the PRAM; and a read cache 1609 made up of nonvolatile memory such as the flash memory. A specific configuration and operations of the cache memory device are the same as those of any one of the first embodiment to the third embodiment. For the interfaces of the adapter 1600, the same interfaces as the interfaces used between the host and the HDD are used.

According to this embodiment, by connecting a host 1610 and an HDD 1602 via the adapter 1600, it is possible to provide an apparatus that meets various requirements such as low cost, high data transfer rate, low power consumption, etc. while much enhancing the effect by the cache.

### Sixth Embodiment

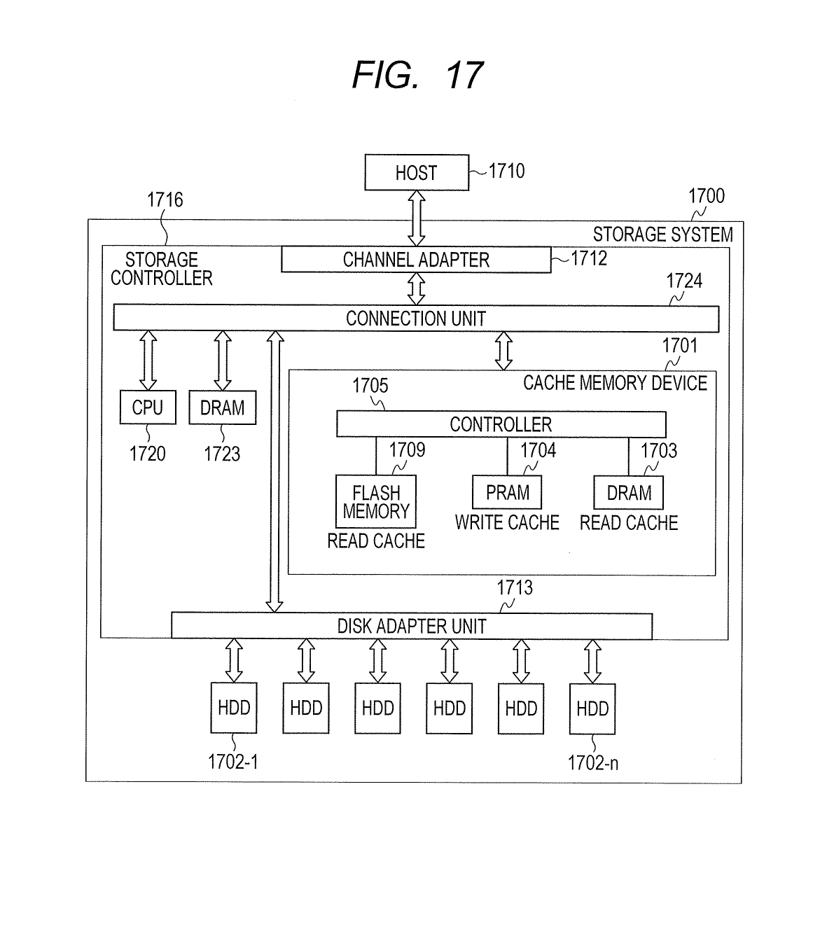

FIG. 17 shows a system configuration example in the case where the information device of the present invention is mounted on a storage system to construct an apparatus. A storage system 1700 of this embodiment is equipped with at least one host 1710, a storage controller 1716, and multiple HDDs 1702-1 to 1702-n. The storage controller 1716 is equipped with a cache memory device 1701, a CPU 1720, DRAM 1723, a channel adapter unit 1712, a disk adapter unit 1713, and a connection unit 1724 of a bus etc. The cache memory device 1701 includes a controller 1705 and three kinds of cache memories: a volatile memory read cache 1703; a nonvolatile memory write cache 1704; and a nonvolatile memory read cache 1709. As one example, the DRAM is used for the volatile memory read cache 1703, the PRAM is used for the nonvolatile memory write cache 1704, and the flash memory is used for the nonvolatile memory read cache 1709. A specific configuration and operations of the cache memory device 1701 are the same as those of the cache memory device of any one of the first embodiment to the third embodiment.

The host 1710 is a computer equipped with a CPU, memory, etc., recognizes logically storage areas of the plurality of HDD's 1702-1 to 1702-n provided by the storage controller 1716, and executes an application program using these logical storage areas (logical volumes). The disk adapter unit 1713 is a microcomputer, which functions as an interface for the HDD's 1702-1 to 1702-n.

According to this embodiment, it is possible to provide the storage system that meets the various requirements of low cost, high data transfer rate, low power consumption, etc. while much enhancing the effect by the cache.

What is claimed is:

1. An information device disposed on a data transfer path between a computer and a storage device having different data processing speeds, comprising:
a nonvolatile memory read cache to store read data requested by the computer and which is read from the storage device; and
a nonvolatile memory write cache to store write data received from the computer and which is to be stored in the storage device,
wherein the nonvolatile memory read cache and the nonvolatile memory write cache are separate, and have a physical principal each other and have a difference in any characteristics of write endurance, read performance, write performance, power consumption and cost.

2. The information device according to claim 1,
wherein the nonvolatile memory write cache is nonvolatile memory whose write endurance is high and the nonvolatile memory read cache is nonvolatile memory whose write endurance is lower than that of the nonvolatile memory write cache, and
wherein the nonvolatile memory read cache does not store the write data to be stored in the storage device.

3. The information device with cache memories according to claim 2,
wherein a nonvolatile memory write-data management table for managing cache data on the nonvolatile memory write cache and a nonvolatile memory read-data management table for managing cache data on the nonvolatile memory read cache are stored in the nonvolatile memory write cache.

4. The information device according to claim 1,
wherein a nonvolatile memory write-data management table for managing cache data on the nonvolatile memory write cache is stored in the nonvolatile memory write cache, and
a nonvolatile memory read-data management table for managing cache data on the nonvolatile memory read cache is stored in the nonvolatile memory read cache.

5. The information device according to claim 1,
wherein the nonvolatile memory write cache has a fast write speed and a low read speed, and the nonvolatile memory read cache has a fast read speed and a low write speed.

6. The information device according to claim 3,
wherein the each data management table has an entry for counting access frequency for each read or write of the cache data and the counting of the access frequency is performed for a minimum unit of the cache data or a predefined unit area.

7. The information device according to claim 2, further comprising:
a volatile memory,
wherein in a cache miss of the nonvolatile memory read cache, the data being read from the storage device that is a read request destination is temporarily cached in the volatile memory and the read data is made possible to be transferred therefrom, and
wherein the data temporarily cached in the volatile memory is transferred to the nonvolatile memory read cache.

8. The information device according to claim 6, further comprising:
a volatile memory,
wherein in a cache miss of the nonvolatile memory read cache, the data is temporarily stored in the volatile memory, pieces of data whose access frequencies are high are extracted by counting the read access frequencies, and those pieces of data are transferred to the nonvolatile memory read cache.

9. The information device with cache memories according to claim 6,
wherein the read-access frequency of data in the nonvolatile memory write cache for writing is counted, pieces of data whose read access frequencies are high in the nonvolatile memory write cache are extracted, and those pieces of data are transferred to the nonvolatile memory read cache.

10. The information device according to claim 3,
wherein the computer and the storage device are different in data processing speed,
wherein a history of a read-access frequency and a history of a write-access frequency are taken considering all areas on a storage medium of the storage device as objects, data of the area where the read-access frequency is high is written in the nonvolatile memory read cache, and
wherein data where the write-access frequency is low is given priority and is first written in the storage medium from the nonvolatile memory write cache.

11. The information device according to claim 10,
wherein histories of the read-access frequency and the write-access frequency taken considering all the areas on a storage medium of the storage device as objects are recorded in a system area on the storage medium.

12. The information device according to claim 3,
wherein when data is written in the nonvolatile memory write cache, the read data management table of the nonvolatile memory read cache is searched to check whether there exists data of the same area as that of the write data, and when the appropriate data exists, the data will be invalidated in the read data management table of the nonvolatile memory read cache.

13. The information device according to claim 1,
wherein the computer and the storage device are different in data processing speed,
wherein the information device is an adapter for connecting the devices, and
wherein an interface of the adapter is the same interface as an interface used between the computer and the storage device.

14. An information apparatus comprising:
a computer;
a storage device which stores data received from the computer; and
an information device disposed on a data transfer path between the computer and the storage device,
wherein the information device is equipped with:
a controller,
a nonvolatile memory read cache connected to the controller, and
a nonvolatile memory write cache connected to the controller, and
wherein the controller is configured to control the nonvolatile memory read cache to store read data requested by the computer and which is read from the storage device,
wherein the controller is configured to control the nonvolatile memory write cache to store write data received from the computer and which is to be stored in the storage device, and
wherein the nonvolatile memory read cache and the nonvolatile memory write cache have a physical principal each other and have a difference in any characteristics of write endurance, read performance, write performance, power consumption and cost.
